(19) United States
(12) Patent Application Publication
(10) Pub. No.: US 2026/0031657 A1
(43) Pub. Date: Jan. 29, 2026

(54) APPARATUS AND METHOD FOR RECTIFIER CONFIGURATIONS FOR WIRELESS POWER TRANSFER APPLICATIONS AND A WAVEGUIDE-TO-MICROSTRIP COUPLER ARRAY

(71) Applicant: Emrod Limited, Auckland (NZ)

(72) Inventor: Jochem Thomas ROELVINK, Auckland (NZ)

(73) Assignee: Emrod Limited, Auckland (NZ)

(21) Appl. No.: 18/997,604

(22) PCT Filed: Jul. 25, 2023
(86) PCT No.: PCT/IB2023/057544

§ 371 Date: Jan. 22, 2025

Related U.S. Application Data
(60) Provisional application No. 63/391,883, filed on Jul. 25, 2022.

(51) Int. Cl. H02J 50/20; H01P 3/08; H01P 5/08

(52) U.S. Cl. CPC H02J 50/20; H01P 3/081; H01P 5/08

(57) ABSTRACT

A waveguide to transmission line coupler is provided. The waveguide can be capable of guiding electromagnetic energy and can have a plurality of coupling sets along the waveguide. The coupling set can include a non-resonant coupling aperture capable of coupling said electromagnetic energy from the waveguide to at least one output transmission line and a tuning element in the waveguide proximate to said non-resonant coupling aperture thereto, capable of tuning out residual shunt susceptance corresponding to the electromagnetic energy coupled by said non-resonant coupling aperture.

### FIELD OF THE INVENTION

The present invention relates to the field of wireless power transfer, in particular to a non-resonant waveguide to transmission line coupler.

### BACKGROUND

Currently, certain wireless power transfer applications, for example, to Earth from space-born microwave antennas and solar arrays and/or terrestrial power beaming are conceptual technologies that have yet to be practically implemented due to, for example, limitations on the technology that exists to bring these concepts to implementation.

### SUMMARY OF THE INVENTION

In one aspect, the invention includes a waveguide to transmission line coupler. The waveguide is capable of guiding electromagnetic energy. The waveguide includes a plurality of coupling sets along the waveguide. Each coupling set can include a non-resonant coupling aperture capable of coupling said electromagnetic energy from the waveguide to at least one output transmission line, and a tuning element in the waveguide proximate to said non-resonant coupling aperture thereto, capable of tuning out residual shunt susceptance corresponding to the electromagnetic energy coupled by said non-resonant coupling aperture.

In some embodiments, the waveguide has a top side and a bottom side opposite to said top side, and wherein said coupling sets are located on the top and bottom sides of said waveguide. In some embodiments, the output transmission line is a microstrip. In some embodiments, each said non-resonant coupling aperture is connected to two respective output transmission lines.

In some embodiments, the waveguide includes N coupling sets, wherein each coupling set is capable of coupling a fraction 1/N of the electromagnetic energy in the waveguide. In some embodiments, the aperture is a slot. In some embodiments, the electromagnetic energy has a waveguide wavelength, said waveguide wavelength corresponding to free space wavelength of the electromagnetic energy in free space, and wherein the slot has a slot length less than 0.9 of a half-wavelength of the free space wavelength of the electromagnetic energy.

In some embodiments, the electromagnetic energy has a waveguide wavelength, said waveguide wavelength corresponding to free space wavelength of the electromagnetic energy in free space, and wherein the slot has a slot length less than 0.75 of a half-wavelength of the free space wavelength of the electromagnetic energy.

In some embodiments, the radiation loss of electromagnetic energy in the waveguide is less than 10%. In some embodiments, the radiation loss of electromagnetic energy in the waveguide is less than 5%. In some embodiments, the radiation loss of electromagnetic energy in the waveguide is less than 2%.

In some embodiments, the tuning element is iris-shaped. In some embodiments, a branch line coupler associated with each said coupling set, said branch line coupler capable of isolating return energy from the output transmission line of the non-resonant coupling aperture.

In another aspect, the invention involves a wireless power transfer system. The wireless power transfer system includes a transmitting antenna to transmit a microwave power beam. The wireless power transfer system includes a receive antenna array to collect at least a portion of the microwave power beam, wherein the receive antenna array comprises a plurality of waveguide to transmission line couplers. Each waveguide to transmission line coupler includes a waveguide capable of guiding electromagnetic energy, and a plurality of coupling sets along the waveguide. Each coupling set includes a non-resonant coupling aperture capable of coupling said electromagnetic energy from the waveguide to at least one output transmission line, and a tuning element in the waveguide proximate to said non-resonant coupling aperture thereto, capable of tuning out residual shunt susceptance corresponding to the electromagnetic energy coupled by said non-resonant coupling aperture.

In some embodiments, the waveguide has a top side and a bottom side opposite to said top side, and wherein said coupling sets are located on the top and bottom sides of said waveguide. In some embodiments, the output transmission line is a microstrip.

In some embodiments, each said non-resonant coupling aperture is connected to two respective output transmission lines.

In some embodiments, the wireless transfer system includes N coupling sets, wherein each coupling set is capable of coupling a fraction 1/N of the electromagnetic energy in the waveguide.

In some embodiments, the aperture is a slot.

In some embodiments, the electromagnetic energy has a waveguide wavelength, said waveguide wavelength corresponding to free space wavelength of the electromagnetic energy in free space, and wherein the slot has a slot length less than 0.9 of a half-wavelength of the free space wavelength of the electromagnetic energy.

In some embodiments, the electromagnetic energy has a waveguide wavelength, said waveguide wavelength corresponding to free space wavelength of the electromagnetic energy in free space, and wherein the slot has a slot length less than 0.75 of a half-wavelength of the free space wavelength of the electromagnetic energy.

In some embodiments, the radiation loss of electromagnetic energy in the waveguide is less than 10%. In some embodiments, the radiation loss of electromagnetic energy in the waveguide is less than 5%.

In some embodiments, the radiation loss of electromagnetic energy in the waveguide is less than 2%. In some embodiments, the tuning element is iris-shaped.

In some embodiments, the wireless transfer system includes a branch line coupler associated with each said coupling set, said branch line coupler capable of isolating return energy from the output transmission line of the non-resonant coupling aperture.

In another aspect, the invention involves a receive antenna array. The receive antenna array includes a plurality of waveguide to transmission line couplers. Each waveguide to transmission line coupler includes a waveguide capable of guiding electromagnetic energy, and a plurality of coupling sets along the waveguide. Each coupling set includes a non-resonant coupling aperture capable of coupling said electromagnetic energy from the waveguide to at least one output transmission line, and a tuning element in the waveguide proximate to said non-resonant coupling aperture thereto, capable of tuning out residual shunt susceptance corresponding to the electromagnetic energy coupled by said non-resonant coupling aperture.

In some embodiments, the waveguide has a top side and a bottom side opposite to said top side, and wherein said coupling sets are located on the top and bottom sides of said waveguide.

In some embodiments, the output transmission line is a microstrip. In some embodiments, each said non-resonant coupling aperture is connected to two respective output transmission lines.

In some embodiments, the receive antenna array includes N coupling sets, wherein each coupling set is capable of coupling a fraction 1/N of the electromagnetic energy in the waveguide. In some embodiments, the aperture is a slot.

In some embodiments, the electromagnetic energy has a waveguide wavelength, said waveguide wavelength corresponding to free space wavelength of the electromagnetic energy in free space, and wherein the slot has a slot length less than 0.9 of a half-wavelength of the free space wavelength of the electromagnetic energy.

In some embodiments, the electromagnetic energy has a waveguide wavelength, said waveguide wavelength corresponding to free space wavelength of the electromagnetic energy in free space, and wherein the slot has a slot length less than 0.75 of a half-wavelength of the free space wavelength of the electromagnetic energy.

In some embodiments, the radiation loss of electromagnetic energy in the waveguide is less than 10%. In some embodiments, the radiation loss of electromagnetic energy in the waveguide is less than 5%. In some embodiments, the radiation loss of electromagnetic energy in the waveguide is less than 2%. In some embodiments, the tuning element is iris-shaped.

In some embodiments, the receive antenna array comprises a branch line coupler associated with each said coupling set, said branch line coupler capable of isolating return energy from the output transmission line of the non-resonant coupling aperture.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1A and FIG. 1B shows a schematic diagram of an example of a typical WPT system with a rectenna, according to some embodiments of the invention.

FIG. 2 shows a schematic diagram of an example of a receive antenna array having n rectifier modules, where n is the number of receiving antenna elements, according to some embodiments of the invention.

FIG. 3a, FIG. 3b, FIG. 3c and FIG. 3d show schematic diagrams of receive antenna array and rectifier modules configurations, according to various embodiments of the invention.

FIG. 4A is a schematic diagram of a rectangular waveguide to transmission line coupler having a resonant slot, according to the prior art.

FIG. 4B is a theoretical equivalent circuit of a waveguide to microstrip coupler, according to the prior art.

FIG. 4C is a graph of normalized shunt admittance of a waveguide to microstrip coupler as a function of longitudinal resonant slot offset o, according to the prior art.

FIG. 5A is a schematic diagram of a waveguide to transmission line coupler having a non-resonant coupler aperture, according to some embodiments of the invention.

FIG. 5B shows a graph of theoretical equivalent circuit normalized shunt conductance and susceptance for a transmission line coupler having a non-resonant coupler aperture as a function of the tuning element, according to some embodiments of the invention.

FIG. 6 shows a graph of radiation loss as a function of number of elements in a array, comparing waveguide to transmission line couplers having a resonant slots of the prior art vs. non-resonant slots, according to embodiment of the invention.

FIG. 7A is a schematic diagram of ten element end fed linear array of non-resonant slots, according to some embodiments of the invention.

FIG. 7B show a graph of example of output of the array of FIG. 7A of port |S₁₁| as a function of frequency, according to some embodiments of the invention.

FIG. 7C show a graph of example of output of the array of FIG. 7A of ports |Sₘ₁| as a function of frequency, where m is one of the 20 microstrip ports, according to some embodiments of the invention.

FIG. 8 shows a schematic diagram of a branch-line couplers with non-resonant slot waveguide to microstrip coupler arrays, according to an embodiment of the invention.

It will be appreciated that for simplicity and clarity of illustration, elements shown in the FIGS. have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the invention can be practiced without these specific details. In other instances, well-known methods, procedures, and components, modules, units and/or circuits have not been described in detail so as not to obscure the invention.

Generally, the invention can include a power arrangement which can include combining power collected by receive antenna to cause one or more equal (or substantially equal) power outputs that can be delivered to one or more rectifier modules. In this manner, the rectifier modules can be identical.

Generally, the invention can include a power arrangement which can include a waveguide to transmission line coupler that includes non-resonant slot cuts in the waveguide.

Long range wireless power transfer (“WPT”) or “power beaming” applications exist. A typical common feature among many existing systems for power beaming is that individual elements in the receive antenna array couple directly to discrete rectifying elements. Such a receiving antenna arrangement is typically referred to as a “rectenna” (e.g., rectifying antenna).

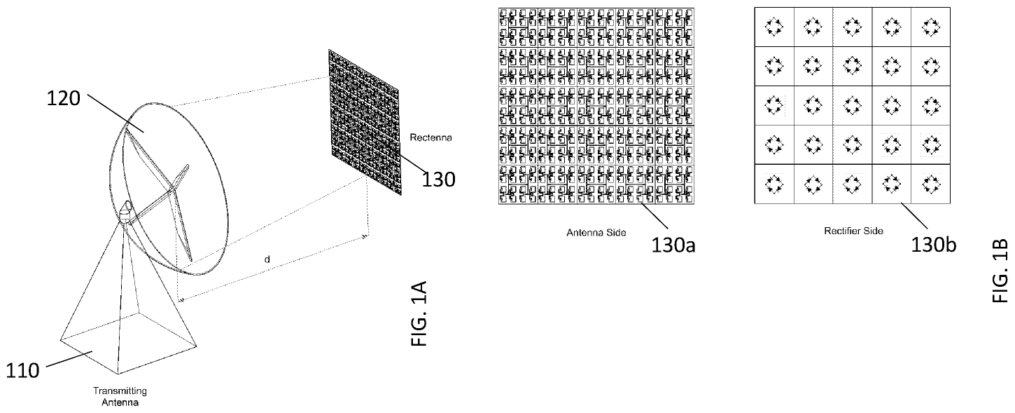

FIG. 1A and FIG. 1B shows a schematic diagram of an example of WPT system with a rectenna, according to some embodiments of the invention. A high-power microwave source 110 connects to a transmitting antenna 120. The transmitting antenna 120 can be a parabolic reflector antenna or phased array antenna. A receiving antenna (e.g., rectenna) array 130 that includes a number of discrete antenna elements is located a distance, d, away from the transmitting antenna 120. The transmitting antenna 120 can shape and/or focus a microwave power beam exiting the transmitting antenna 120. The receiving antenna array 130 can collect at least a portion of the microwave power beam (e.g., radiated power). The radiated power impinged upon the face of the rectenna array 120 facing the receive antenna array 130, e.g., the antenna side 130a, can be coupled directly to a discrete number of microwave rectifying elements 130b. The microwave rectifying elements 130b can be located on the backside of the receive antenna array 130, e.g., on a face of the receive antenna array 130 that is not facing the transmitting antenna 120, to for example, minimize transmission line losses, in close proximity to the receiving antenna elements.

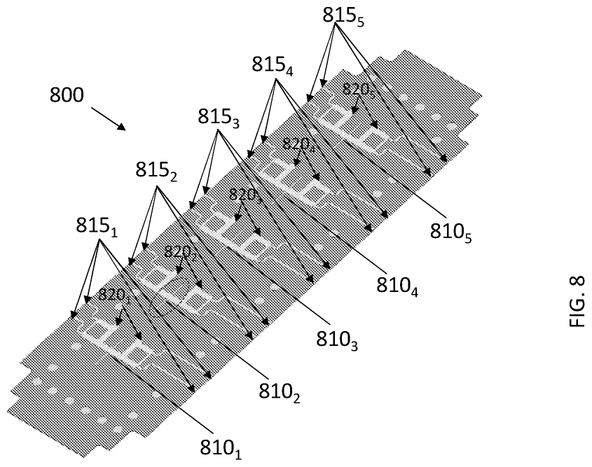

Generally, discrete microwave rectifying elements used in a typical rectenna generally have relatively low power handling capability, e.g., high frequency Schottky diodes that can typically operate with input powers of less than 100 mW at 5.8 GHz, which can be insufficient for industrial-scale WPT applications. In order to couple the relatively large amount (e.g., >100 Watts) of microwave power that can be supported by a waveguide transmission line to the relatively low power-handling PCB-based rectifying circuitry, it can be desirable to efficiently couple microwave power via a waveguide-to-microstrip coupler array (e.g., as described in further detail below with respect to FIG. 5A, 7A, and/or FIG. 8).

One typical difficulty with diode-based microwave rectification is that the input impedance of the diode typically is a function of the input power. To maximize RF-to-DC conversion efficiency, it can be desirable for the input and output tuning networks and the load resistance to be optimized via tuning networks for the expected amount of input power. The use of these tuning networks with fast Schottky diodes can result in excellent RF-to-DC conversion efficiencies but the efficiency is typically sensitive to the input power.

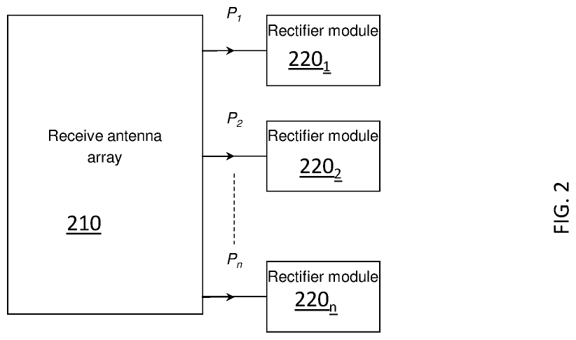

For a WPT arrangement (e.g., as shown in FIG. 1A and FIG. 1B) there can be, for example, hundreds of discrete elements in the receiving antenna array, all of which can receive different or varying amounts of microwave power depending on the power distribution over the receiving antennas aperture. Each of the receiving antenna elements can be coupled directly to distinct rectifying circuitry, each tuned to the expected amount of incident power in order to achieve satisfactory conversion efficiency, for example, as shown in FIG. 2.

FIG. 2 shows a schematic diagram of an example of a receive antenna array 210 having n rectifier modules, where n is the number of receiving antenna elements, according to some embodiments of the invention. As shown in FIG. 2, the power at rectifier module 2201, and 2202 and 220n is different, as P₁≠P₂≠Pₙ and thus, for optimal efficiency, each rectifier modules can be different (e.g., have different input and output tuning networks and different DC load resistances). In some embodiments, it can be impractical to have different rectifier modules for each receive antenna array element.

Accordingly, it can be desirable to have a more efficient, practical, and easily implementable solution.

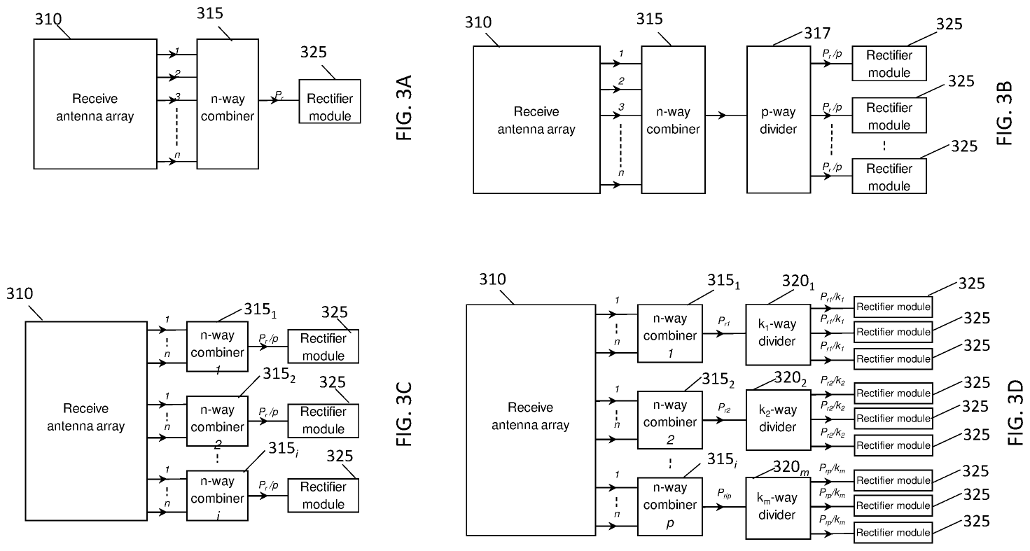

FIG. 3a, FIG. 3b, FIG. 3c and FIG. 3d show schematic diagrams of receive antenna array and rectifier modules configurations, according to various embodiments of the invention. In general, the receive antenna array configurations of FIG. 3a, FIG. 3b, FIG. 3c and FIG. 3d can deliver constant power (or substantially constant power) to the input of rectifier modules such that identical rectifier modules can be used. The rectifier modules can each include a waveguide to transmission line (e.g., waveguide to microstrip) coupler array (e.g., as described in further detail below with respect to FIGS. 5A, 7A and 8). For example, power going into the rectifier modules can be directed to the waveguide to microstrip coupler arrays whose output can be coupled to the rectifier circuitry (e.g., diodes) which can do AC to DC conversion.

For example, turning to FIG. 3a, FIG. 3a shows a schematic diagram of receive antenna array 310 having n outputs that are input to an n-way combiner 315, according to some embodiments of the invention. The n-way combiner 315 has one output, Pr to the rectifier module 325. In various embodiments, each rectifying module 325 (e.g., diode array) can accept in the order of 20-200 Watts of input power (e.g., depending on the frequency).

FIG. 3b shows a schematic diagram of receive antenna array 310 having n outputs that are input to an n-way combiner 315. The output of the n-way combiner 315 is input to a p-way divider 317. The p-way divider 317 is output to multiple rectifier modules 325. The p-way divider 317 can divide the power delivered to the rectifier modules such that each is Pᵣ/p. The p-way divider 317 can be used if, for example, Pᵣ is higher than the rectifier module can handle (e.g., 50-5000 Watts).

FIG. 3c shows a schematic diagram of receive antenna array 310 having groups of n outputs where each group is input to an n-way combiner 3151, 3152, . . . 315i, generally 315. Each of the n-way combiners 315 are connected to a rectifier module, and output Pᵣ/p. The multiple n-way combiners 315 can be used, for example, if, Pᵣ is higher than the rectifier module can handle and instead of the p-way divider 317.

FIG. 3d shows a schematic diagram of receive antenna array 310 having groups of n outputs where each group is input to an n-way combiner 3151, 3152, . . . 315p, generally 315. The n-way combiners 315 output unequal power, Pᵣ₁-to-Pᵣₚ. The k-way power dividers 3201, 3202, . . . 320m, generally 320, can have a corresponding different power division ratios, k₁-to-kₘ are then used such that the condition Pᵣ₁/k₁=Pᵣ₂/k₂=Pᵣₚ/kₘ is satisfied. In this manner, the power delivered to each rectifier module 325 can be equivalent, with a number of rectifier modules 325 based on the total power received by the antenna array divided by the input power of each rectifier module. For example, 10 kW of received power would require 20 rectifier modules, with 500 W of input power to each rectifier module.

In various embodiments, the total receive power divided by the maximum input power of each rectifier module can be the basis for a minimum number of rectifier modules that can be used, while the total receive power divided by the minimum input power of each module can be the basis for a maximum number of modules to be used. For this particular configuration of FIG. 3d, k1+k2, . . . +kn rectifier modules can be used.

As described in FIG. 3a, FIG. 3b, FIG. 3c and FIG. 3d, it can be desirable for the rectifier modules to be delivered equal input power, e.g., Pᵣ, Pᵣ/p, or Pᵣₚ/kₘ. In some embodiments, within the rectifier modules, the input/output tuning networks and the output DC load resistance can be identical. This can be advantageous for industrial scale WPT systems which can use on the order of many hundreds of rectifier modules.

Waveguides can serve as a high power (e.g., in the Megawatt range) microwave transmission line and can have low insertion loss. Therefore, it can be desirable for rectifying elements (e.g., rectifier modules) to have waveguide inputs.

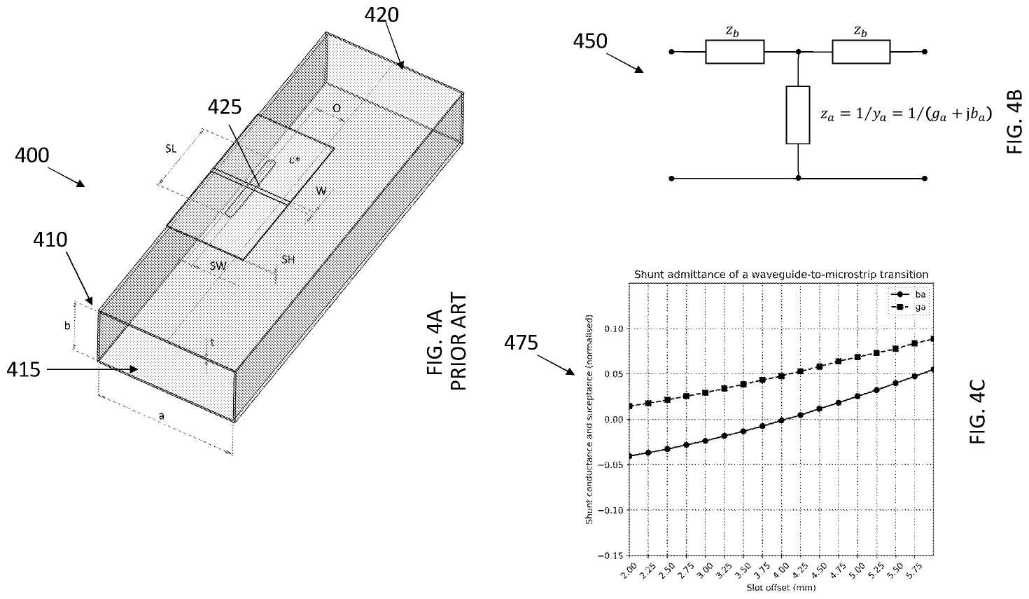

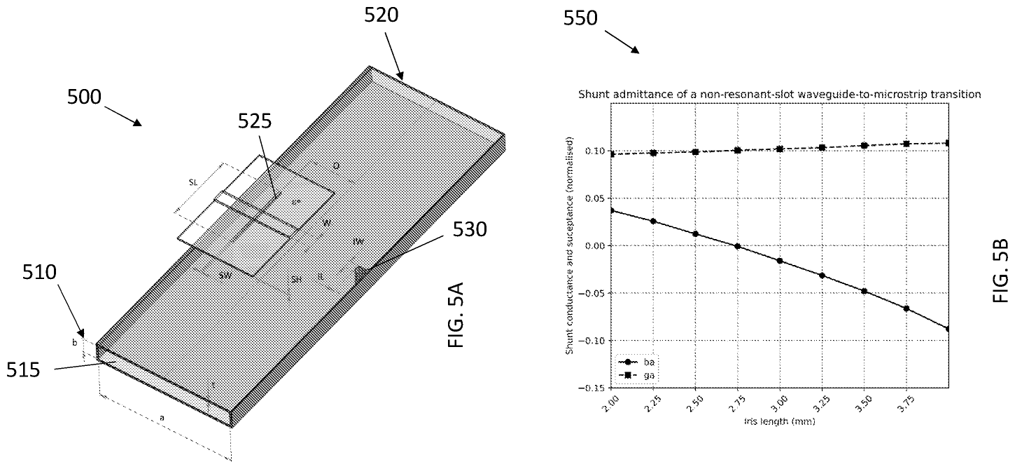

Arrays of slots cut into rectangular waveguides are typically used to form slotted waveguide antennas. In slotted waveguide antenna arrays, typically the dominant propagating mode in the waveguide causes an electric field across each slot of a particular amplitude and phase, and at least a portion of a propagating waveguide mode is radiated from the slot. FIG. 4A is a schematic diagram of a rectangular waveguide to transmission line coupler 400 having a resonant slot, according to the prior art. As shown in FIG. 4A, the waveguide to transmission line coupler 400 having a width a and a thickness b, a first end 410 having a port 415, a second end 420, a longitudinal resonant slot 425 having a length SL and width SW.

In the rectangular waveguide 410, (and typically in rectangular waveguides), during propagation through the waveguide the dominate TE10 mode electric field is perpendicular to the direction of the propagation with guide wavelength, λ_{g}. The longitudinal slot 425 can be represented by an equivalent circuit with a single shunt admittance, yₐ=gₐ+jbₐ (normalized to the characteristic impedance TE10 waveguide mode), where g is conductance, b is susceptance and j2=−1. By appropriate selection of the slot dimensions, the susceptance bₐ can be made equal to zero and the longitudinal slot 425 can be modelled as a single shunt conductance. When bₐ=0, yₐ=gₐ and the slot is considered to be resonant. By spacing n resonant slots apart by a length of λg/2, where n=1/gₐ, and terminating the waveguide with an appropriate termination (e.g., a short or open circuit) a slotted waveguide antenna array can be formed, and all (or substantially all) of the energy contained in the TE10 waveguide mode is radiated by the slots. In this scenario some of the energy radiated by the longitudinal resonant slot couples to the microstrip transmission line but some of the energy also radiates into free space. To use the waveguide as described above, it can be desirable to maximize the amount of energy that couples directly to a microstrip transmission line (e.g., formed on a printed circuit board (“PCB”) that attaches directly to the waveguide) and minimize the amount of energy that radiates into free space.

Typical existing waveguides, e.g., the rectangular waveguide 410 with resonant slot lengths as shown above, are not suitable for waveguide to microstrip coupler arrays due to, for example, power loss. For example, assume the rectangular waveguide 410 of FIG. 4A is coupled to a microstrip line. Microstrip lines can be formed on a top side of a PCB, with relative permittivity ε*, placed directly on top of the waveguide, perpendicular to the longitudinal resonant slot (e.g., longitudinal resonant slot 425 as shown in FIG. 4A). A bottom metal layer of the PCB can be cut out around the longitudinal slot. This arrangement can be represented by a generalized theoretical equivalent circuit, as shown in FIG. 4B. Turning to FIG. 4B, FIG. 4B is a theoretical equivalent circuit 450 of a waveguide to microstrip coupler, according to the prior art. By considering an incident wave at one waveguide port (e.g., waveguide 400 and port 415 as shown in FIG. 4A) and assuming that the other ports (e.g., waveguide and microstrip) are terminated in a perfect match, then:

$${z}_{a} = \frac{2 τ}{{( 1 - ρ )}^{2} - {τ}^{2}} \qquad EQN . 1$$

$${z}_{b} = - \frac{ρ - τ + 1}{ρ - τ - 1} \qquad EQN . 2$$

where zₐ and z_{b} are normalized impedances and ρ and τ are the reflection and transmission coefficients (e.g., S₁₁ and S₂₁), respectively, relative to the central plane of the slot discontinuity. In general, for a narrow (e.g., <0.1λ₀, where λ₀ is the free space wavelength) longitudinal resonant slot with microstrip perpendicular to the slot, the series impedance is negligibly small, i.e., z_{b}=0, and the equivalent circuit reduces to a single shunt admittance, yₐ=1/zₐ. Some typical results for the shunt admittance, determined from numerical simulation results for ρ and τ with Ansys HFSS, are shown in FIG. 4C. FIG. 4C is a graph of normalized shunt admittance of a waveguide (e.g., waveguide 400 of FIG. 4A) to microstrip coupler as a function of longitudinal resonant slot (e.g., longitudinal resonant slot 425 of FIG. 4A) offset o, according to the prior art. As the slot offset, o, is increased both gₐ and bₐ can increase, and when o≅4 mm, bₐ=0 and the slot is considered resonant. For these dimensions gₐ≅0.05 and so, for an end-fed linear array, these dimensions and configuration are suitable for n=1/gₐ≅20 elements, spaced Δ_{g}/2 apart. At least one difficulty is that the generalized theoretical equivalent circuit of FIG. 4B treats the waveguide of FIG. 4A as a two-port network, when it is a four-port network, e.g., two waveguide ports and two microstrip ports. Assuming that the excited waveguide port is port one, then an expression for the port one power balance:

$${PB}_{1} = {\vert {S}_{11} \vert}^{2} + {\vert {S}_{21} \vert}^{2} + {\vert {S}_{31} \vert}^{2} + {\vert {S}_{41} \vert}^{2} \qquad EQN . 3$$

where S₁₁, S₂₁, S₃₁, and S₄₁ are scattering parameters for the four-port network. In an ideal lossless system, PB₁=1. However, waveguides and PCB's are typically not lossless and typically one or more components of the power exiting the slot typically does not couple to the microstrip line but is radiated instead. Power can also be dissipated in the substrate and there can be resistive conductor losses. For example, assume the waveguide-to-microstrip coupler example discussed with respect to FIGS. 4A, 4B and 4C, at slot resonance (o≅4 mm) PB₁=0.99169, or 0.831% of the power is lost due to radiation. Also noteworthy, in this example, no other losses are modelled, e.g., Im(ε*)=0 and the conductors were assumed as perfect electric conductors. The deviation of PB from unity can be due to radiated power. The radiated power loss can be per element in the array. For a twenty (20) element array, for example, the total energy lost due to radiation can be ˜16.62%. Such a level of loss can be unacceptable in WPT applications, where system efficiency is of great importance.

Therefore, it can be desirable to have a waveguide to transmission line coupler that minimizes power losses.

FIG. 5A is a schematic diagram of a waveguide to transmission line (e.g., microstrip) coupler 400 having a non-resonant coupler aperture, according to some embodiments of the invention. The waveguide to transmission line coupler 500 includes a width a and a thickness b, a first end (e.g., waveguide end) 515 having a port 515, a second end 520, a top side 530 and a bottom side 535, a non-resonant coupler aperture 525 (e.g., longitudinal slot, rectangular slot) having a length SL and width SW, and a tuning element 530.

The non-resonant coupler aperture 525 has dimensions, a length SL and width SW such that non-resonant coupler aperture 525 is non-resonant, e.g., slot dimensions where bₐ≠0. A waveguide-based reactive tuning element 530 can be positioned in a proximity to non-resonant coupler aperture 525 (e.g., at the central plane of the slot discontinuity) to tune out residual shunt susceptance of the non-resonant slot, such that bₐ can be zero. A non-resonant coupler aperture 525 and corresponding tuning element 530 can be a coupling set.

In some embodiments, the waveguide to transmission line coupler 500 and the non-resonant coupler aperture 525 has dimensions a=34.85 mm, b=4.0 mm, t=0.5 mm, SW=0.5 mm, SL=18.0 mm, o=11.75 mm, SH=0.38 mm, W=3.0 mm, IW=2.0 mm, ε*=2.16−j0, f=5.8 GHz.

In some embodiments, where the non-resonant slot is capacitive, bₐ>0, the tuning element 525 can be an inductive waveguide iris (e.g., iris-shaped). In some embodiments, the non-resonant coupler aperture 525 can have dimensions such that there is residual inductance. In these embodiments, the tuning element 530 can be capacitive. The waveguide-based tuning element can be metallic, dielectric posts, iris′, stub lines and/or any tuning element as is known in the art. During operation, an electromagnetic wave is impinged upon the waveguide end 515, the waveguide to transmission line coupler 500 guides the electromagnetic wave such that at least a portion exits the non-resonant coupler aperture 525. The portion of the electromagnetic wave that exists the non-resonant coupler aperture 525 can be coupled to the transmission line (e.g., microstrip). The tuning element 525 can tune out residual shunt susceptance corresponding to the electromagnetic energy coupled by said non-resonant coupler aperture.

The waveguide to transmission line coupler 500 with a non-resonant coupler aperture 525 can allow strong coupling (e.g., relatively high gₐ) without significant radiation loss. For example, turning to FIG. 5B, FIG. 5B shows a graph 550 of theoretical equivalent circuit normalized shunt conductance and susceptance for a transmission line coupler having a non-resonant coupler aperture as a function of the tuning element (e.g., inductive iris length, IL), according to some embodiments of the invention. The inductive iris can tune out residual capacitance of the non-resonant slot, and that, for these particular dimensions gₐ=0.1 when bₐ≅0. When used as an element in an end-fed linear antenna array the waveguide to transmission line coupler 500 can be suitable for n=1/gₐ≅10 elements, spaced λ_{g}/2 apart. The power balance can be PB₁=0.99863. In this manner, the total loss due to radiation from the 10-element array can be ˜1.37%, which is significantly lower than for arrays made from resonant slots, as described above with respect to FIGS. 4A, 4B and 4C.

In some embodiments, the electromagnetic energy impinged upon the waveguide has a waveguide wavelength corresponding to a free space wavelength of the electromagnetic energy in free space, and wherein the slot has a slot length less than 0.9 of a half-wavelength of the free space wavelength of the electromagnetic energy.

In some embodiments, the electromagnetic energy has a waveguide wavelength, said waveguide wavelength corresponding to free space wavelength of the electromagnetic energy in free space, and wherein the slot has a slot length less than 0.75 of a half-wavelength of the free space wavelength of the electromagnetic energy.

In various embodiments, the radiation loss of electromagnetic energy in the waveguide end is less than 2%, 5% or 10%.

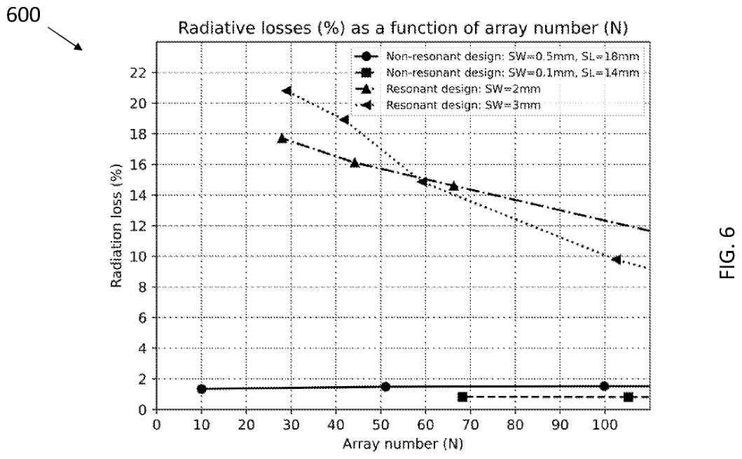

FIG. 6 shows a graph of radiation loss as a function of number of elements in a array, comparing waveguide to transmission line couplers having a resonant slots of the prior art vs. non-resonant slots, according to embodiment of the invention. For the non-resonant slots, the loss due to radiation remains low regardless of the number of elements in the array. While, for resonant slots, the results do show a reduction in radiation losses with increasing array number, it should be noted that array numbers greater than about 50 are not expected to be practically realizable due to the ever-tighter machining tolerances necessary to ensure an equal power split.

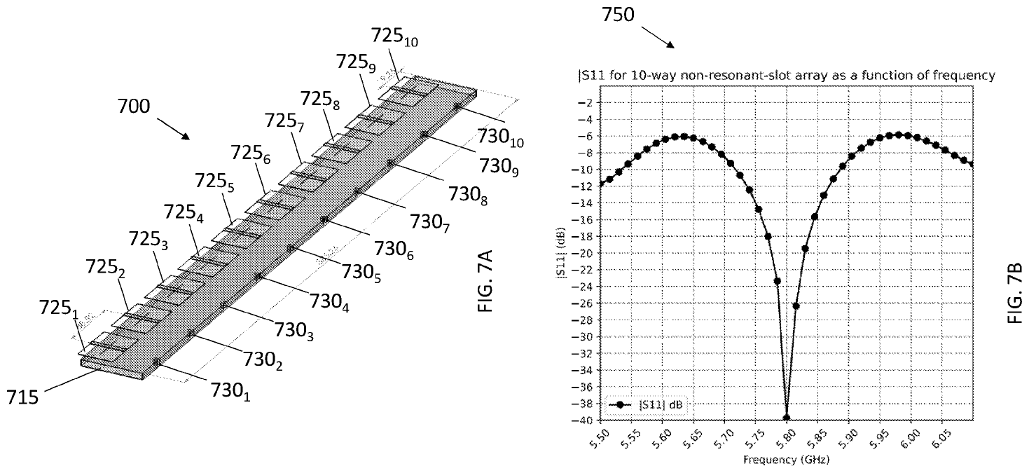

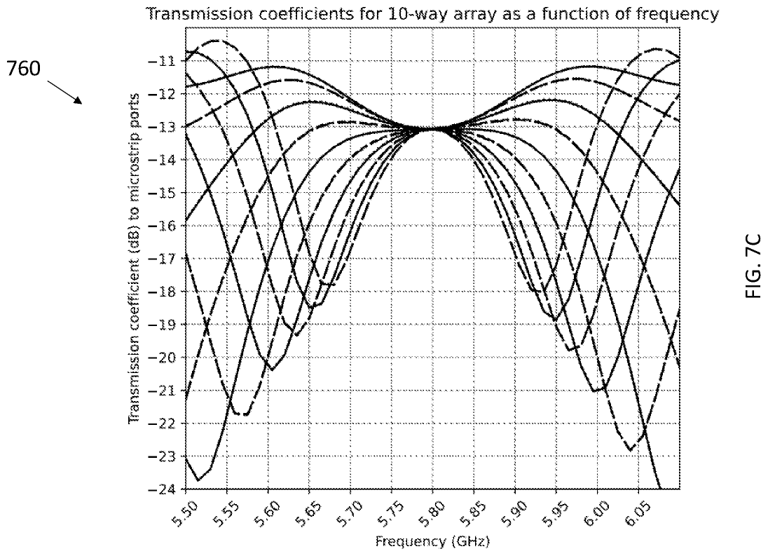

FIG. 7A is a schematic diagram of ten element linear array of non-resonant slots 700, according to some embodiments of the invention. The ten element linear array of non-resonant slots 700 includes a first end 715, and a plurality of coupling sets, where each coupling set include a non-resonant slot with a tuning element. As shown in FIG. 7A, the non-resonant slots 7251, 7252, 7253, 7254, 7255, 7256, 7257, 7258, 7259, 72510, generally non-resonant slots 725 have corresponding tuning elements 7301, 7302, 7303, 7304, 7305, 7306, 7307, 7308, 7309, 73010, respectively, generally tuning elements 730.

Each of the non-resonant slots 725 can have dimensions as shown above in FIG. 5B.

The slot can be spaced from center slot to center slot at λg/2 apart, and the waveguide can be terminated in a short circuit spaced λg/4 away from the last element. For an example 10-element linear array, the waveguide and non-resonant slot dimensions can be a=34.85 mm, b=4.0 mm, t=0.5 mm, SW=0.5 mm, SL=18.0 mm, o=11.75 mm, SH=0.38 mm, W=3.0 mm, IW=2.0 mm, IL=2.75 mm, ε*=2.16−j0. At f=5.8 GHz the TE10 waveguide wavelength is λ_{g}=77 mm. The total length of the ten-element linear array of non-resonant slots 700 can be 385 mm.

During operation, the electromagnetic energy is impinged upon the first end 715 and fed through the ten element linear array of non-resonant slots 700. Each non-resonant slot with tuning element 730 couples 1/10th of the wave energy out of the waveguide. The tuning element 730 ensures that all of the electromagnetic energy impinged upon the waveguide is evenly coupled through the ten non-resonant slots.

In various embodiments, non-resonant slots are positioned on the top and bottom surface of the ten element linear array of non-resonant slots 700. This can have the advantage of reducing the overall length of non-resonant-slot coupler arrays and/or to increase the number of outputs for a given length. For example, each non-resonant slot 7251 can have a corresponding slot on the bottom surface of the waveguide, such that, for example, the waveguide shown in FIG. 7A has 20 slots rather than 10 slots.

FIG. 7B shows a graph of example of output of the array of FIG. 7A of port |S₁₁| (e.g., output of slot 7251) as a function of frequency, according to some embodiments of the invention. The ten element linear array of non-resonant slots 700 is well matched a frequency of 5.8 GHZ and the 10 dB bandwidth is about 3%. This can be similar to some known patch antenna arrays, and considered acceptably high for WPT applications, which are typically inherently narrowband.

FIG. 7C shows a graph of example resultant transmission coefficients, which represent the power transmitted from the waveguide port to the 20 microstrip ports, e.g., the two microstrip ports for every coupler element, as shown in FIG. 7A. As shown in FIG. 7C, at 5.8 GHz the transmission coefficient varies between −13.08 dB and −13.05 dB. FIG. 7C also shows that the elements that are placed further away from the short circuit termination exhibit more rapid variation with frequency. In some embodiments, this effect can limit the maximum number of elements that can be used in the array since, for example, eventually the transmission coefficient of the elements furthest from the short circuit can become too sensitive to small changes in frequency or machining tolerances.

In various embodiments, the end fed linear array of non-resonant slots 700 is more than 10 elements, less than 10 elements or any number of elements.

In various embodiments, for diode-based microwave rectification the input impedance of the diode can be a function of the input power. The rectifier circuits can be fabricated on PCBs and the rectifier circuits can be connected to the array of microstrip line outputs (e.g., as shown in FIG. 7A). When combined with the antenna/rectifier configurations as shown, for example, in FIGS. 3A, 3B, 3C, and/or 3D, a single rectifier module can be used for the expected amount of input power (e.g., Pᵣ, Pᵣ/p, Pᵣₚ/kₘ). When the input power to the rectifier module is equal to the target value, the rectifier module can be well matched and the reflection coefficient can be similar to that as shown in FIG. 7B. If, however, the input power deviates from its target value and/or some of the rectifier circuits are damaged (e.g., thermal-based diode failure), the input impedance to the rectifier circuits can deviate from their intended value, and the magnitude of the reflection coefficient can be non-zero. Some of the power incident upon the rectifier module can be reflected back to the receive antenna array, and/or radiate back towards the antenna array. In a WPT system this can be a system inefficiency, but can also pose a safety risk, and it can be desirable to avoid it. In some embodiments, a multiport transmission line junction (e.g., a branch-line coupler) can be used.

The branch line coupler can be a four-port junction. The four-port junction can be configured to operate as follows: The power incident upon the input power can be equally divided between the two output ports. The fourth port can act as an isolation port and no (or substantially no) power flows into this port when the two output ports are well matched. When the output ports are mismatched, (e.g., when the power to the rectifier circuit deviates from its target value), the power reflected from the output ports can flows into the isolation port, rather than the input port. In this way, the rectifier modules can be made to inherently matched, and situations where power is reflected from the rectifier module can be avoided entirely. Additional benefits of the use of the branch-line coupler is that the number of microstrip outputs can be doubled, and/or the input power to the rectifier module can be doubled.

FIG. 8 shows a schematic diagram 800 of a branch-line couplers with non-resonant slot waveguide to microstrip coupler arrays, according to an embodiment of the invention. The schematic diagram 800 includes five branch-line coupler to non-resonant slot to microstrip couplers arrays having ten microstrip outputs (e.g., which can connect to rectifier circuits, for example, rectifier modules as described above in FIGS. 3A, 3B, 3C and/or 3D). Each of the five branch-line coupler to non-resonant slot to microstrip couplers arrays having ten microstrip output can include an isolation port 820n, four output ports 815n, and a slot 810n.

In these embodiments, each slot 810 is coupled to more than one output transmission line (e.g., the four output ports 815 n).

When branch-line coupler 800 is placed in close proximity to the non-resonant slots, the evanescent fields typically in the vicinity of the slot can couple directly to the branch-line coupler. For a compact, close-coupled, slot-to-microstrip-to-branch-line coupler, the branch-line dimensions can be adjusted to account for the evanescent coupling. The output of an isolation port of each branch-line coupler can be connected to either: a power resistor, a detector for failure detection in the rectifier module, an additional rectifier module for improving the RF-to-DC conversion efficiency of the rectifier module, or a combination of all of these.

The branch-line coupler can be used in the rectifier modules to, for example, improve impedance transformation. In some embodiments, the rectifier circuit can be a harmonically-tuned rectifier circuit and can require an impedance matching network to achieve maximum RF-to-DC conversion efficiency. The characteristic impedance of the microstrip-line input can be 500 such that the impedance matching section can transform the 500 line to the optimal input impedance for the diode/harmonic filter of the rectifier circuit. The impedance transformation can be built into the branch-line coupler and an additional circuit economy, e.g., with correspondingly higher RF-to-DC conversion efficiency.

In various embodiments, the waveguide can be manufactured by forming the broadwalls (e.g., the top and bottom walls, with width a, since a>b) by the bottom layer of the PCB with the coupler slots etched out of the bottom layer metallization by PCB lithographic processes and/or other standard PCB manufacturing techniques as are known in the art. The microstrip transmission lines can be formed on the top layer of the PCB. For double sided arrays, the machined metallic part of the coupler array is then the waveguide narrow-wall, the “frame”, and the top and bottom PCBs are affixed to the frame by a low ohmic affixing method such as bolting, soldering and/or conductive adhesive. For a single sided array, e.g., as shown in FIG. 7A described above, the waveguide narrow walls (e.g., the side walls with height b, as b<a) and the bottom broadwall, can be formed in metal from machining, extruding and/or other known processes as are known in the art. The top PCB can be affixed to this. The slot thickness, t, can be set by the metallization thickness of the PCB and can be small (e.g., 35 μm).

In some embodiments, the non-resonant-slot waveguide coupler can achieve very low radiation loss. For example, for a 10-element array example with 20 microstrip outputs a 100 W (input) rectifier block can be implemented that can achieve 85% RF-to-DC conversion efficiency used with GaN and/or GaAs Schottky diodes, capable of about 5 W input at 5.8 GHz, and suitable harmonically-tuned rectifier circuitry.

As is apparent to one of ordinary skill in the art, the receive antenna array, rectifier module and/or waveguide to transmission line coupler as described above can be coupled to one or more computing elements that is capable of receiving electromagnetic energy, rectified electromagnetic energy and interpret it using various computing elements/devices and/or programs as is known in the art.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A waveguide to transmission line coupler comprising:
a waveguide capable of guiding electromagnetic energy; and
a plurality of coupling sets along the waveguide, each coupling set including:
a non-resonant coupling aperture capable of coupling said electromagnetic energy from the waveguide to at least one output transmission line, and
a tuning element in the waveguide proximate to said non-resonant coupling aperture thereto, capable of tuning out residual shunt susceptance corresponding to the electromagnetic energy coupled by said non-resonant coupling aperture.

2. The waveguide coupler of claim 1, wherein the waveguide has a top side and a bottom side opposite to said top side, and wherein said coupling sets are located on the top and bottom sides of said waveguide.

3. The waveguide coupler of claim 1, wherein the output transmission line is a microstrip.

4. The waveguide coupler of claim 1, wherein each said non-resonant coupling aperture is connected to two respective output transmission lines.

5. The waveguide coupler of claim 1, comprising N coupling sets, wherein each coupling set is capable of coupling a fraction 1/N of the electromagnetic energy in the waveguide.

6. The waveguide coupler of claim 1, wherein the aperture is a slot.

7. The waveguide coupler of claim 6, wherein the electromagnetic energy has a waveguide wavelength, said waveguide wavelength corresponding to free space wavelength of the electromagnetic energy in free space, and wherein the slot has a slot length less than 0.9 of a half-wavelength of the free space wavelength of the electromagnetic energy.

8. The waveguide coupler of claim 6, wherein the electromagnetic energy has a waveguide wavelength, said waveguide wavelength corresponding to free space wavelength of the electromagnetic energy in free space, and wherein the slot has a slot length less than 0.75 of a half-wavelength of the free space wavelength of the electromagnetic energy.

9. The waveguide coupling of claim 1, wherein the radiation loss of electromagnetic energy in the waveguide is less than 10%.

10. The waveguide coupling of claim 1, wherein the radiation loss of electromagnetic energy in the waveguide is less than 5%.

11. The waveguide coupling of claim 1, wherein the radiation loss of electromagnetic energy in the waveguide is less than 2%.

12. (canceled)

13. (canceled)

14. A wireless power transfer system, comprising:
a transmitting antenna to transmit a microwave power beam; and
a receive antenna array to collect at least a portion of the microwave power beam, wherein the receive antenna array comprises a plurality of waveguide to transmission line couplers, each waveguide to transmission line coupler comprising:
a waveguide capable of guiding electromagnetic energy, and
a plurality of coupling sets along the waveguide, each coupling set including:
a non-resonant coupling aperture capable of coupling said electromagnetic energy from the waveguide to at least one output transmission line, and
a tuning element in the waveguide proximate to said non-resonant coupling aperture thereto, capable of tuning out residual shunt susceptance corresponding to the electromagnetic energy coupled by said non-resonant coupling aperture.

15. The wireless transfer system of claim 14, wherein the waveguide has a top side and a bottom side opposite to said top side, and wherein said coupling sets are located on the top and bottom sides of said waveguide.

16. The wireless transfer system of claim 14, wherein the output transmission line is a microstrip.

17. The wireless transfer system of claim 14, wherein each said non-resonant coupling aperture is connected to two respective output transmission lines.

18. The wireless transfer system of claim 14, comprising N coupling sets, wherein each coupling set is capable of coupling a fraction 1/N of the electromagnetic energy in the waveguide.

19. The wireless transfer system of claim 14, wherein the aperture is a slot.

20. The wireless transfer system of claim 19, wherein the electromagnetic energy has a waveguide wavelength, said waveguide wavelength corresponding to free space wavelength of the electromagnetic energy in free space, and wherein the slot has a slot length less than 0.9 of a half-wavelength of the free space wavelength of the electromagnetic energy.

21. The wireless transfer system of claim 19, wherein the electromagnetic energy has a waveguide wavelength, said waveguide wavelength corresponding to free space wavelength of the electromagnetic energy in free space, and wherein the slot has a slot length less than 0.75 of a half-wavelength of the free space wavelength of the electromagnetic energy.

22. The wireless transfer system of claim 14, wherein the radiation loss of electromagnetic energy in the waveguide is less than 10%.

23. The wireless transfer system of claim 14, wherein the radiation loss of electromagnetic energy in the waveguide is less than 5%.

24. The wireless transfer system of claim 14, wherein the radiation loss of electromagnetic energy in the waveguide is less than 2%.

25-39. (canceled)
